(19) United States
(12) Patent Application Publication
(10) Pub. No.: US 2004/0119700 A1
(43) Pub. Date: Jun. 24, 2004

(54) Touch sensitive input system

(76) Inventor: Fumiko Ichikawa, Espoo (FI)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/323,821

(22) Filed: Dec. 20, 2002

(51) Int. Cl. G09G 5/00

(52) U.S. Cl. 345/173

(57) ABSTRACT

An apparatus, such as a mobile telephone or another PDA and a method of operating the apparatus, which apparatus comprises a touch pad or touch screen where the operator manually enters or draws characters. On a display, such as on a touch screen, is illustrated the parts entered so far, and these parts are replaced by an illustration of the character when identified. If the operator exerts an excessive force to the touch pad or touch screen, a predetermined illustration, such as an illustration resembling an ink stain, is illustrated at a position of the display corresponding to the position of the touch pad or touch screen where the excessive force was applied.

### BACKGROUND OF THE INVENTION

The present invention relates to an apparatus, such as a mobile telephone or another type of PDA, and a method of operating it, the apparatus being adapted to have an operator enter, on a touch pad, one or more parts of a character and to determine which character the operator enters. If the operator exerts an excessive force to the touch pad, a predetermined image or illustration is provided in a corresponding position of a display or monitor on which the parts having been entered are shown to the operator.

A problem is seen in touch pads when the operators provide excessive forces thereto. Even during normal operation, non-linearities of touch pads may be seen after extensive use—and especially in areas thereof which are used the most. However, excessive forces increase this effect tremendously.

Pressure sensitive touch pads or touch screens have been described, such as for use in drawing where a larger pressure provides a broader line on the monitor. However, this does not inform the operator of a situation where an excessive force is applied and the operator is in the process of actually destroying the touch pad.

### SUMMARY OF THE INVENTION

Thus, the present invention addresses this problem, and in a first aspect, the invention relates to an apparatus for receiving hand written characters or signs from an operator. The apparatus includes:

a touch pad for the operator to use for entering a character,

a display,

means for controlling the display to illustrate to the user any part(s) of the character entered so far,

means for, on the basis of the entering of the operator, identifying a character, taken from a predetermined set of characters,

means for having the controlling means replace, on the display, the part(s) illustrated with a predetermined representation of the determined character, and

means for determining whether the operator, during entering, exerts an excessive force to the touch pad and for, if so,

determining a position of the touch pad receiving the excessive force and

having the display display a predetermined image or illustration on a corresponding position of the display.

In this context, an entered part will normally be a line or curve entered by the user or operator by pressing e.g. an object against the touch pad while moving the object to form the line or curve.

In the present context, a character may be any character from any alphabet—or signs, such as smileys or other signs used in electrical communication. A character may also be a Chinese or Japanese sign or word or a sign or word from other languages or alphabets.

Thus, the user or operator will be informed when an excessive force has been applied, but this does not alter the resulting character in that the resulting, displayed character is a predetermined one which is independent on whether an excessive force was applied or not.

In the present context, the predetermined image illustrated when an excessive force is experienced may be any illustration. Presently, an illustration resembling an ink stain is preferred.

Preferably, the controlling means are adapted to illustrate—on the display or monitor—the entered part(s) until the replacing means are operated. Alternatively or in addition, a time out mechanism may be operative which clears the entered parts without replacing, if no character could be identified within a predetermined period of time.

In a preferred embodiment, the controlling means are adapted to have the display illustrate the entered part(s) in a first area of the display and the predetermined representation of the identified character in another part of the display. The illustration of the parts and the representation are then preferably made in two different points in time.

Also, in this embodiment, the controlling means are preferably adapted to have the display illustrate predetermined representations of a number of previously identified characters or signs. When the characters are e.g. part of a sentence, it is helpful to the user or operator to be able to see where in that sentence he/she is at the moment.

In this context, the touch pad may be any means having a surface and which is able to derive information from a depression or force exertion thereon describing a curve or line. This touch pad may have only that functionality or an additional functionality such as to also be adapted to illustrate the line or curve described during the depression or force exertion—or other visual information. A touch pad also being adapted to illustrate information is normally termed a touch screen. Thus, in that situation, which is, in fact, a preferred embodiment of the present invention, a touch screen may be used which embodies the touch pad and the display.

In general, the touch pad is adapted to not only determine at which positions thereof a force has been applied, but it is also adapted to determine either how large the force was—or whether the force exceeded a given threshold or not. Then, the determining means could be adapted to determine that an excessive force has been exercised when a force exceeding a predetermined threshold is exercised.

It is desired that the corresponding in which the predetermined illustration is provided is a position where the actually entered part is draws—and more precisely the position in the part in which the excessive force was applied.

In one situation:

the touch pad has a number of different positions thereon,

the display illustrates the entered part(s) in a predetermined area thereof having a number of different positions therein, where a correlation exists between each position of the touch pad and the positions of the display, and

the determining means are adapted to, upon determining that an excessive force has been exercised, determine the corresponding position from the correlation.

A touch pad will have a number of sensitive areas or positions each informing a controller of a depression, if one is sensed. Also, displays will have a number of positions each controllable to illustrate or not information (such as a coloured dot). A correlation between such positions is easy to determine.

In one embodiment, the controlling means area adapted to, upon determination of an excessive force, control the display to illustrate only a part of the actual part of the character entered until the excessive force was exercised. Thus, not only is the user or operator informed of the fact that an excessive pressure is applied; he/she also cannot continue entering the part. Re-entering of the part or at least releasing the pressure from the pad may be required.

In a second aspect, the invention relates to a mobile telephone comprising an apparatus as described above.

A third aspect relates to a method of operating the above apparatus or mobile telephone, the method comprising:

the touch pad receiving one or more parts of a character entered by an operator,

a displaying step where the controlling means control the display to illustrate, to the operator, the part(s) having been entered,

the identifying means comparing the entered part(s) with predetermined information relating to corresponding characters,

when the identifying means have decided which character is being entered, replacing the part(s) illustrated with a predetermined representation of the determined character,

during the entering, upon the operator exerting an excessive force to the touch pad, illustrating, on the display and in a position corresponding to a position of the touch pad where the excessive force was applied, a predetermined image or illustration.

The actual identification of the character from the part(s) entered is a standard technique, which has been used in PDA's for years. In such PDA's the parts entered are characterized (line lengths, bent, straight, curved, and the sequence thereof) and compared to a database on the basis of which the character entered is identified.

Preferably, the replacing step comprises replacing the illustrated part(s) with the same corresponding representation irrespective of whether excessive force was applied or not. This is preferred in order to be independent of whether the user/operator excessively forced/depressed the pad.

Also, the controlling step may comprise illustrating the entered part(s) until the replacing step takes place. Alternatively, a time-out may be observed where after the part(s) are erased without replacing.

In a preferred embodiment, the controlling step comprises having the display illustrate the entered part(s) in a first area of the display and the predetermined representation of the identified character in another part of the display.

In that embodiment, the controlling step preferably comprises having the display illustrate predetermined representations of a number of previously identified characters.

In another preferred embodiment, the determining step comprises determining that an excessive force has been exercised when a force exceeding a predetermined threshold is exercised.

Also, preferably:

the touch pad has a number of different positions thereon,

the display illustrates the entered part(s) in a predetermined area thereof having a number of different positions therein, where a correlation exists between each position of the touch pad and the positions of the display, and

the determining step comprises, upon determining that an excessive force has been exercised, determining the corresponding position from the correlation.

Finally, controlling step may comprise, upon determination of an excessive force, controlling the display to illustrate only a part of the actual part of the character entered until the excessive force was exercised.

### BRIEF DESCRIPTION OF THE DRAWINGS

In the following, the invention will be described with reference to the drawings, wherein:

FIG. 1 illustrates an apparatus having a touch pad, a display illustrating the part(s) entered and a display illustrating previously identified characters or signs,

FIG. 2 illustrates a display holding both the part(s) entered and the previously identified characters or signs,

FIG. 3 illustrates the use of a touch screen, and

FIG. 4 illustrates a preferred embodiment of an illustration displayed upon exertion of excessive force on the touch pad.

### DETAILED DESCRIPTION OF THE INVENTION

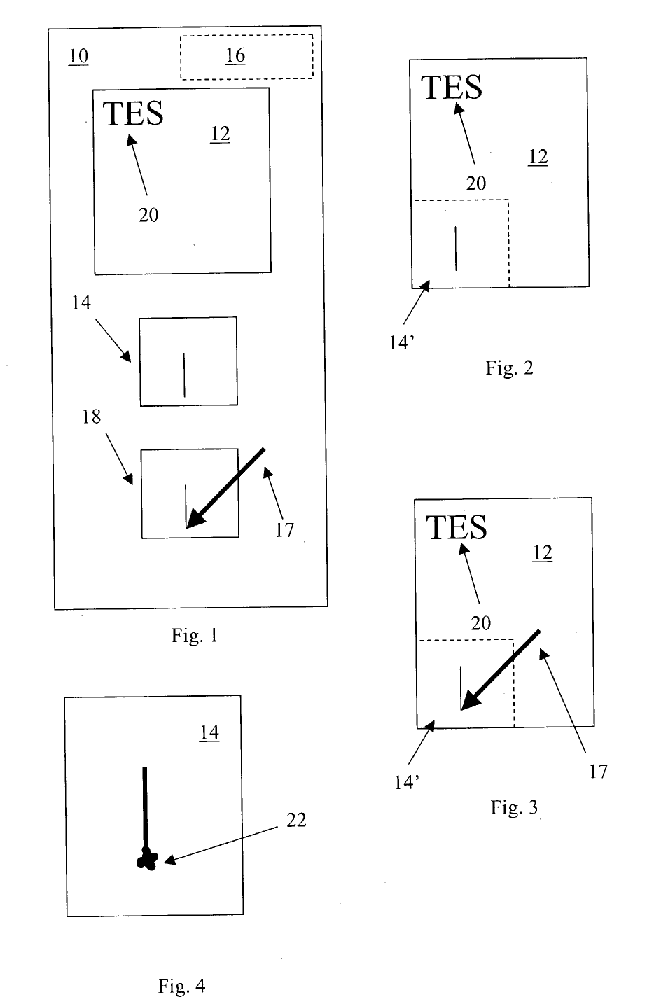

FIG. 1 shows parts of a mobile telephone 10. These parts are a display 12, a second display 24, a touch pad 18, a stylus 17 for operating the touch pad 18, and a controller or CPU 16 for controlling these parts of the telephone 10. In the present context, the CPU may be a standard processor, a RISC processor, a SPARC processor, a DSP, CISC, or any software programmable processor.

The operator draws characters or signs on the pad 18 with the stylus 17. These characters or signs are normally drawn part by part, such as line by line. One line has been drawn on the pad 18 (the line is illustrated) and each part drawn is illustrated on the display 14. Concurrently with the drawing of the parts, the controller 16 will attempt to identify the actual character, which the operator is entering, or drawing. When such identification is possible, the corresponding character is illustrated on the display 12, and the parts illustrated on the display 14 are erased in order for the mobile telephone 10 to be ready for the entering of a new character.

The representations of the characters or signs will be predetermined bitmaps or the like stored in a memory, such as a RAM, a ROM, a PROM, a EPROM, a EEPROM, a disc, an optical disc, an optical memory, or a tape memory, in the processor. Naturally, these characters or signs, such as represented by an alphabet, may be replaced in order for the same hardware to be used in different countries or regions—or in order to obtain the possibility of entering specific signs.

On the display 12, a number of previously entered and identified characters or signs are provided at 20 in order for the operator to be able to determine where in e.g. a sentence he/she is.

FIG. 2 illustrates a single display 12 where the display 14 has been added into the display 12 by reserving a part 14′ of the display 12 for the parts illustrated in the separate display 14 in FIG. 1. Otherwise, the operation may be the same.

In the present embodiment, the display may be any type of display, such as a LED display, a plasma monitor, a CRT, a LCD, active or inactive matrices. However, the preferred type of display is a touch screen as illustrated in FIG. 3.

In FIG. 3, the display 12 is a touch screen, where the stylus 17 is used directly on the part 14′ wherein the parts already entered are illustrated to the user while entering subsequent parts.

In FIG. 4, it is illustrated that when the operator presses the touch pad 18 too hard, a predetermined illustration 22, here resembling an ink stain, is provided in the display 14 and at the position on the actually drawn part, where the operator exceeded the maximum allowed force. Thus, the operator is swiftly informed of the possibility or danger of damaging the pad 18—and that at the position where the operator will look. The operator will look at the display 14 or 14′ representing the parts drawn.

Tests have shown that operators will increase the force applied at narrow curves of the parts—or at the beginning or end of a part.

Thus, in addition to merely determining the position of force applied to the pad 18, the pad informs the controller 16 of the actual force applied in order for the controller 16 to compare that force to a predetermined maximum force. Thus, information is transmitted to the display 14or 14′ of how to draw the part and, if excessive force is applied, to, in addition, illustrate the ink stain, at the corresponding position.

The processor may instruct the display 12 or 14 to not illustrate any further entering on the actual part after the excessive force has been sensed and the illustration 22 provided—until the stylus 17 has been lifted from the pad 14. Also, the last part entered could then be erased so as to be entered again by the operator.

In order to be able to illustrate the parts on the display 14 and 14′, a coordinate system is provided for the pad 18 and for the display 14 or 14′. A correlation between a coordinate in one system and a coordinate in the other is determined, where after shifting between one system and the other is simple.

In the present embodiment, a standard recognition technique is used for determining which characters or signs are entered on the basis of the parts entered by the operator. The conventional way of recognizing a character is that once user starts writing, the location of the pointed area is recorded in a certain time sequence. Based on that, the system can tell whether the operator is still drawing a line, or whether he/she has lifted the pen from the surface. Data collected from this raw data are line lengths, characteristics (bent, straight, curved, etc.). Also information about the line orders is collected. All this data generates a certain sequence, and compared with the database existing in the system.

What is claimed is:

1. An apparatus for receiving hand written characters or signs from an operator, the apparatus comprising:
a touch pad for the operator to use for entering a character,
a display,
means for controlling the display to illustrate to the user any part(s) of the character entered so far,
means for, on the basis of the entries of the operator, identifying a character, taken from a predetermined set of characters,
means for having the controlling means replace, on the display, the part(s) illustrated with a predetermined representation of the determined character, and
means for determining whether the operator, during entering, exerts an excessive force to the touch pad and for, if so,
determining a position of the touch pad receiving the excessive force and
having the display display a predetermined image or illustration on a corresponding position of the display.

2. An apparatus according to claim 1, wherein the controlling means are adapted to illustrate the entered part(s) until the replacing means are operated.

3. An apparatus according to claim 1, wherein the controlling means are adapted to have the display illustrate the entered part(s) in a first area of the display and the predetermined representation of the identified character in another part of the display.

4. An apparatus according to claim 3, wherein the controlling means are adapted to have the display illustrate predetermined representations of a number of previously identified characters or signs.

5. An apparatus according to claim 1, comprising a touch screen embodying the touch pad and the display.

6. An apparatus according to claim 1, wherein the determining means are adapted to determine that an excessive force has been exercised when a force exceeding a predetermined threshold is exercised.

7. An apparatus according to claim 1, wherein:
the touch pad has a number of different positions thereon,
the display illustrates the entered part(s) in a predetermined area thereof having a number of different positions therein, where a correlation exists between each position of the touch pad and the positions of the display, and
the determining means are adapted to, upon determining that an excessive force has been exercised, determine the corresponding position from the correlation.

8. An apparatus according to claim 1, wherein the controlling means area adapted to, upon determination of an excessive force, control the display to illustrate only a part of the actual part of the character entered until the excessive force was exercised.

9. A mobile telephone comprising an apparatus according to claim 1.

10 A method of operating the apparatus according to claim 1, the method comprising:
the touch pad receiving one or more parts of a character entered by an operator,
a displaying step where the controlling means control the display to illustrate, to the operator, the part(s) having been entered,
the identifying means comparing the entered part(s) with predetermined information relating to corresponding characters,
when the identifying means have decided which character is being entered, replacing the part(s) illustrated with a predetermined representation of the determined character,
during the entering, upon the operator exerting an excessive force to the touch pad, illustrating, on the display and in a position corresponding to a position of the touch pad where the excessive force was applied, a predetermined image or illustration.

11. A method according to claim 10, wherein the replacing step comprises replacing the illustrated part(s) with the same corresponding representation irrespective of whether excessive force was applied or not.

12. A method according to claim 10, wherein the controlling step comprises illustrating the entered part(s) until the replacing step takes place.

13. A method according to claim 10, wherein the controlling step comprises having the display illustrate the entered part(s) in a first area of the display and the predetermined representation of the identified character in another part of the display.

14. A method according to claim 13, wherein the controlling step comprises having the display illustrate predetermined representations of a number of previously identified characters.

15. A method according to claim 10, wherein the determining step comprises determining that an excessive force has been exercised when a force exceeding a predetermined threshold is exercised.

16. A method according to claim 10, wherein:
the touch pad has a number of different positions thereon,
the display illustrates the entered part(s) in a predetermined area thereof having a number of different positions therein, where a correlation exists between each position of the touch pad and the positions of the display, and
the determining step comprises, upon determining that an excessive force has been exercised, determining the corresponding position from the correlation.

17. A method according to claim 10, wherein the controlling step comprises, upon determination of an excessive force, controlling the display to illustrate only a part of the actual part of the character entered until the excessive force was exercised.
